(19) United States
(12) Patent Application Publication
(10) Pub. No.: US 2005/0061798 A1
(43) Pub. Date: Mar. 24, 2005

(54) Electric heating apparatus with integrated temperatrure sensor

(75) Inventor: Gunter Uhl, Helmstadt-Bargen (DE)

Correspondence Address: Timothy E. Newholm;Boyle Fredrickson Newholm Stein & Gratz S.C., Suite 1030, 250 East Wisconsin Avenue, Milwaukee, WI, 53202, US

(73) Assignee: Catem GmbH & Co. KG

(21) Appl. No.: 10/937,729

(22) Filed: Sep. 9, 2004

(30) Foreign Application Priority Data
Sep. 22, 2003 (EP) 03021405.0

(51) Int. Cl. H05B 1/02

(52) U.S. Cl. 219/494; 219/497

(57) ABSTRACT

The present invention relates to an electric heating apparatus, particularly as an additional heater for an automotive vehicle, and to a control circuit for an electric heating apparatus that permits a substantially independent operation of the additional heater. The heating power control takes place via a temperature sensor integrated into the additional heater and limit values stored in the control circuit before.

### BACKGROUND OF THE INVENTION

1. Field of the Invention

The present invention relates to an electric heating apparatus, particularly as an additional heater for automotive vehicles.

2. Description of the Related Art

For use in automotive vehicles, particularly automotive vehicles with consumption-optimized diesel engines and, in future, also gas engines in which a reduced amount of heat energy is observed, electric additional heaters are used for heating passenger compartment and engine. Such electric heating apparatuses, however, are also suited for other purposes, for example in the field of building installations, particularly room air conditioning, in industrial plants, or the like.

The standard heating system of an automotive vehicle is connected to the engine cooling circuit and exploits the exhaust heat of the engine for heating the passenger compartment of the vehicle. To this end a water type heat exchanger is arranged in the heating/air conditioning system of the automotive vehicle. The heat exchanger heats the air sucked from the outside by employing the cooling water, having a temperature of around 80° C. to 90° C. The heated air is then supplied to the passenger compartment of the vehicle.

At low outside temperatures, e.g. 0° C., the cooling water temperature is identical with the outside temperature upon start of the engine. Hence, the passenger compartment cannot be heated via the cooling water, but only after a few minutes as soon as the cooling water has heated up and the cooling water temperature is clearly above the outside temperature.

The period of time in which the exhaust heat of the engine is not available yet for heating purposes can be spanned by using electric additional heaters in the heating/air conditioning system of an automotive vehicle. Electric additional heaters already reach their operating temperature after a few seconds and can thus heat the air flowing therethrough accordingly.

PTC heating elements that convert electrical power into heat are preferably used for such electric additional heaters used in heating/air conditioning systems of automotive vehicles. The PTC heating elements are in heat-conducting communication with radiator elements. The heat generated by the PTC heating elements is discharged via the radiator elements to the air flowing through them.

The whole assembly consisting of a layered structure of PTC heating elements, radiator elements and contact sheets, which serve to supply power, is subjected to a clamping pressure for enhancing efficiency. Thanks to this clamping the electrical and thermal contacting of the PTC heating elements is improved.

The electric additional heaters typically have a power consumption ranging from 1,000 W to 2,000 W. With this power consumption, the onboard electrical system of the vehicles is loaded to a considerable degree. To keep the onboard electrical system load as small as possible, the additional heater will be switched off as soon as the cooling water provides adequate heating power via the water type heat exchanger.

A possible criterion that can be used for switching off the electric additional heater is the cooling water temperature. When the cooling water has reached a temperature of about 80° C., there is sufficient heating power available via the cooling water, so that the electric additional heater can be switched off.

Instead of the cooling water temperature criterion, a time criterion can alternatively be used. The electric additional heater will be switched off after start of the engine as soon as a fixedly predetermined time interval has passed since the start of the engine, for instance five minutes.

For controlling the on/off switching of the additional heater, corresponding information in the form of electrical signals must be supplied to said heater. To this end, the electric heating apparatus is normally connected via a data bus, for instance a CAN or LIN bus, to an onboard electrical system of the vehicle for transmitting control and information signals.

Since the electric additional heaters in their switched-on state consume a lot of power in the range of 1,000 W to 2,000 W, the onboard electrical system of the automotive vehicle is under a correspondingly strong load. To prevent the additional heater from taking more electrical power from the onboard electrical system than can be provided for it, a corresponding signal is additionally supplied to the electric additional heater.

The signal which is indicative of the available electrical power is supplied either via the data bus to the heating apparatus or as a separate signal. Preferably, the DF signal of the generator of the automotive vehicle is used for this purpose. The DF signal, representing the generator energizing current, indicates the degree of utilization of the vehicle generator. In dependence upon said signal, the electrical heating power can be adjusted such that it never happens that more power is taken from the generator than is just being generated by the same. Hence, this can successfully prevent a situation where more energy must be taken from the battery because of a negative charge balance.

The electric additional heaters of the conventional type have the drawback that they must be connected to external signal lines, particularly a data bus. The additional costs entailed thereby are disproportionately great especially in vehicles of the lower price classes because in these types of vehicles different variants of heating/air conditioning systems are used. On the one hand, inexpensive simple systems, i.e. “manual” air conditioning systems, must be connectable, but on the other hand also more expensive and comfortable systems with an “automatic air conditioning”. Hence, to be able to use a single additional heater type for all variants of a heating/air conditioning system, said heater type is unnecessarily complicated, thereby causing unnecessarily high costs in the less expensive automotive vehicles.

### OBJECTS AND SUMMARY OF THE INVENTION

It is therefore an object of the present invention to provide a control circuit for operating an electric heating apparatus, an electric heating apparatus, and a method for operating an electric heating apparatus, in which the efforts for coupling the heating apparatus to external control signals can be reduced.

This is achieved with the features of the independent patent claims.

Under a first aspect of the invention, a control circuit is provided for operating an electric heating apparatus, particularly as an additional heater for an automotive vehicle. The heating apparatus comprises PTC heating elements and a temperature sensor which senses the temperature of the air flowing into the heating apparatus. The control circuit contains a storage means for storing a predetermined temperature value. A comparator compares the temperature sensed by the temperature sensor with the stored temperature threshold value. An activation means serves to enable or interrupt the power supply to the PTC heating elements in response to the comparative result of the comparator.

Under a further aspect of the invention, a heating apparatus is provided, particularly as an additional heater for an automotive vehicle. The heating apparatus contains PTC heating elements and a temperature sensor sensing the temperature of the air flowing into the heating apparatus. Moreover, the heating apparatus comprises a control circuit for enabling or disabling the power supply to the PTC heating elements. The control circuit contains a storage means, a comparator and an activation means. The storage means stores a predetermined temperature threshold value, the comparator compares the temperature sensed by the temperature sensor with the stored temperature threshold value, and the activation means serves to enable or disable the power supply to the PTC heating elements in response to the comparative result of the comparator.

Under a further aspect of the invention, a method is provided for operating an electric heating apparatus, particularly as an additional heater for an automotive vehicle. The heating apparatus contains PTC heating elements and a temperature sensor which senses the temperature of the air flowing into the heating apparatus. First of all, an actual temperature value of the air flowing into the heating apparatus is sensed. Subsequently, the sensed temperature value is compared with a stored fixed temperature threshold value. In dependence upon the comparative result, the power supply to the PTC heating elements is enabled or disabled.

It is the basic idea of the invention to sense the temperature of the air flowing into the heating apparatus. The heating power of the heating apparatus, especially a switching on/off, is controlled in dependence upon the difference between the sensed temperature value of the inflowing air and a stored fixed temperature value. The electric additional heater can thereby control “itself” without the need for the supply of an external signal that is e.g. indicative of the cooling water temperature.

Hence, with the present invention, it is possible to simplify the electrical connection of an electric additional heater in an automotive vehicle to the vehicle onboard electrical system, and a correspondingly less expensive design of the additional heater is thereby made possible. Particularly, a connection to a data bus of an onboard electrical system of the automotive vehicle can be omitted. The information on on/off switching is solely adjusted in dependence upon the temperature of the air flowing into the heating apparatus and upon the control logic of the invention.

Preferably, the power supply to the PTC heating elements is enabled when the sensed temperature falls below the stored temperature value. It can thereby be ensured in a simple way that the hearing apparatus will only take power from the onboard electrical system if there is actually a demand for heating. An external control signal or a signal supplied by a user is not needed therefor.

Preferably, the temperature threshold value is within the range between 5° C. and 15° C., particularly preferably between 8° C. and 10° C. With these temperature values, it can be ensured that the electric heating apparatus will only be switched on in cases where there is actually a heating demand in the passenger compartment of the automotive vehicle.

According to a preferred embodiment, the start of the automotive vehicle is sensed and the heating apparatus will only be switched on if there is a heating demand when the automotive vehicle is switched on. Hence, the low amount of exhaust heat of the vehicle engine during start can be bridged in a simple way.

According to a further preferred embodiment the time is sensed that has passed since the switching off of the engine. It can thereby be found out in a simple way whether the residual heat of the cooling water is sufficient for heating the passenger compartment.

According to a further preferred embodiment a predetermined period of time is permanently stored. Upon start of the engine the time that has passed since the switching off of the engine is compared with the predetermined period of time. When the sensed period of time falls below the predetermined value, the supply of power to the PTC heating elements is inhibited.

The predetermined period of time that is compared with the sensed period of time is preferably within the range of 1 to 5 hours, particularly preferably within the range of 2 to 3 hours. It can thereby be ensured in an easy way that the residual heat of the engine is taken into account in the decision as to whether the electric heating apparatus is switched on.

According to an alternative embodiment the stored temperature threshold value is weighted before comparison with the sensed temperature of the supply air. In addition to the air temperature, other influences can thereby be taken into account in an easy way as to whether the heating apparatus is to be switched on.

Preferably, the stored temperature threshold value is raised in dependence upon the time that has passed since the switching off of the engine, i.e. such that the raised temperature threshold approaches the stored temperature threshold value with an increasing period of time. Hence, the residual heat still existing in the engine can be taken into account in a simple way.

According to a further preferred embodiment the stored temperature threshold value is changed such that said value is first raised to an increased temperature threshold value and is lowered to the stored temperature threshold value with an increasing period of time that has passed since the switching off of the engine.

Preferably, the stored temperature threshold value is lowered from a raised temperature threshold value to the stored temperature threshold value within a time interval between a first predetermined time after the switching off of the engine and a second predetermined time after the switching off of the engine. A sudden temperature change in the air supplied to the passenger compartment of the vehicle can thereby be avoided.

The power supply to the PTC heating elements is interrupted between the switching off of the engine and the first predetermined time after the switching off of the engine. Thus, independently of the temperature value within the period of time up to the first predetermined time, the electric additional heater is thus not switched on, and an unnecessary consumption of electrical energy from the onboard electrical system is efficiently avoided.

According to a further preferred embodiment the energy supplied by the PTC heating elements in the switched-on state can be adjusted. The heating power can thereby be adapted in an easy way to the desired temperature, which is e.g. predetermined by the passenger compartment.

Preferably, the heating power of the PTC heating elements is set in response to the electrical energy available in the onboard electrical system of the automotive vehicle. It can thereby be prevented in a reliable way that the onboard electrical system is overloaded and energy is taken from the vehicle battery.

The amount of power available in the onboard electrical system of the automotive vehicle is preferably supplied via an external signal line to the control circuit. Particularly, the DF signal of the automotive generator is used therefor.

According to a further preferred embodiment, the heating power of the PTC heating elements is set in response to the sensed temperature of the supply air. As a result, the heating power which is adapted to the respective situation can be adjusted in an easy way.

Preferably, the heating power of the PTC heating elements is set to a maximum value during operation as long as the sensed supply air temperature is lower than a first predetermined temperature. In the temperature range next thereto, the heating power can then be lowered step by step or continuously. Hence, a transition range between the maximum heating power range and a temperature range in which no heating power is needed can be realized. An unpleasant sudden change in temperature in the passenger compartment of the vehicle is thereby avoided when the heating power is automatically switched off, but the heating power is reduced when the first threshold value is reached, i.e. preferably until a second predetermined temperature of the inflowing air is reached.

Preferably, the heating power of the electric additional heater is reduced when a threshold temperature between 10° C. and 25° C., particularly preferably between 18° C. and 22° C., is reached. Within a temperature range between 50° C. and 90° C., preferably between 75° C. and 85° C., of the inflowing air, the heating power of the additional heater reaches the value zero.

Further advantageous designs of the invention are the subject of the subclaims.

### BRIEF DESCRIPTION OF THE DRAWINGS

The present invention will now be explained with reference to preferred embodiments taken in conjunction with the attached drawings. The drawings show in detail in

FIG. 1 a perspective view of an exemplary design of an electric heating apparatus with an integrated control circuit;

FIG. 2 a schematic view of the layered structure of the heating elements and radiator elements arranged in the heating apparatus according to FIG. 1;

FIG. 3 a diagram with a schematic illustration of the modification of the temperature threshold value [symbol] ᵥ in dependence on time Tₐᵤₛ that has passed since the switching off of the engine;

FIG. 4 a diagram with a schematic illustration showing the dependence on the heating power P to be supplied by the electric heating apparatus and on the temperature [symbol] ᵢₙ of the air flowing into the heating apparatus; and

FIG. 5 a block diagram showing an exemplary embodiment of a control circuit according to the present invention.

### DETAILED DESCRIPTION OF THE PREFERRED EMBODIMENTS

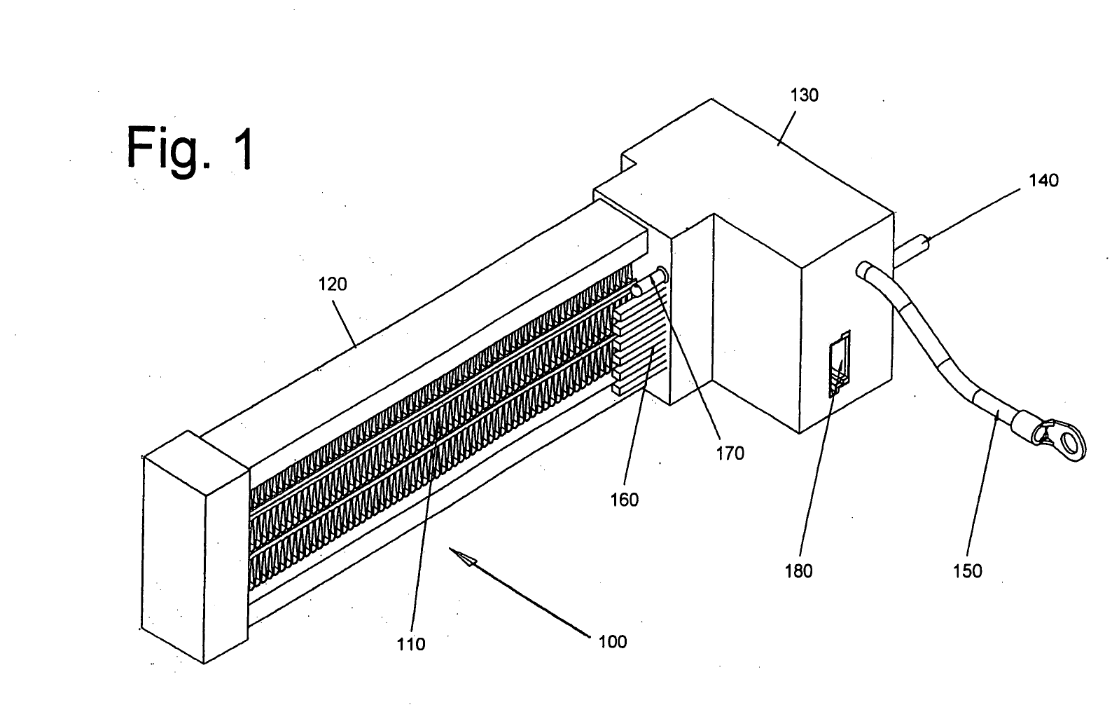

FIG. 1 is a perspective view of a possible embodiment of the additional heater 100 according to the invention. The additional heater has a heating register 110 consisting of radiator elements and PTC heating elements arranged therein. The heating register 110 is arranged within a metal or plastic housing 120. Preferably, the components are held by a clamp fit to enhance the efficiency of the PTC heating elements, namely by improving thermal and electrical contacting.

A control circuit is arranged in a housing section 130 laterally adjoining the housing 120 of the heating register 110. The control circuit determines when power is supplied to the PTC heating elements and in which amounts. To this end the control circuit has a plus terminal 140 and a ground terminal 150. The control circuit supplies power to the PTC heating elements in dependence upon the internal control logic, a signal supplied via a signal connector 180, and the output of the temperature sensor 170. Power semiconductor components are used for power switching. The exhaust heat of said power semiconductor components is supplied to the air flow to be heated via air flags of cooling elements 180 that project into the air flow.

The temperature sensor 170 is arranged such that it is positioned in the air flow of the air to be heated. As a result, the temperature sensor 170 can sense the temperature of the inflowing air and pass it on to the control circuit. The temperature sensor 170 can also be mounted on the housing in a way differing from the one shown in FIG. 1 as long as it is guaranteed that it is not affected by the heating power of the heating register.

The control circuit is preferably supplied via the signal connector 180 with an external signal which is indicative of the electrical power available in the onboard electrical system of the vehicle. As a consequence, the control circuit can set in an automatic way how much power it takes from the onboard electrical system via terminals 140, 150. An overloading of the onboard electrical system and a discharge of the vehicle battery can thereby be prevented in an efficient way.

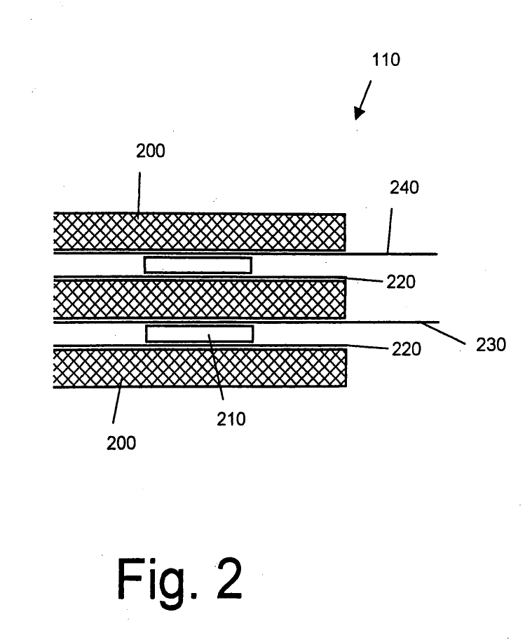

The structure of the heating register 110 is schematically shown in FIG. 2. PTC heating elements 210 are arranged between the radiator elements 200. The two PTC heating elements 210 shown are in heat-conducting communication with the radiator elements 200. The heat generated by the PTC heating element 210 is discharged via the radiator elements 200 to the air flowing through the radiator elements 200.

Contact sheets 220, 230, 240 are arranged at both sides of the PTC heating elements 210. Power is supplied via said contact sheets to the PTC heating element 210. To this end not all of the contact sheets 220, 230, 240 themselves have to be provided with a power terminal. FIG. 2 shows two contact sheets 230, 240 guided out of the heating surface to the right side. The two contact sheets 230, 240 guided outwards may be connected with an opposite power potential. Preferably, the contact sheet 220 is also connected to the potential of the contact sheet 230 via the intermediate radiator element 220 of an electrically conductive configuration. In this way a few terminals are enough for the power supply to the PTC heating elements.

The structure illustrated in FIG. 2 shows the arrangement principle in a schematic way only. Preferably, the structure is held by a clamp fit so that there is a particularly smooth thermal and electrical transition between the PTC heating element 210 and the contact sheets 220, 230 and 240.

To keep the number of the electrical signals to be supplied to the additional heater as small as possible, the temperature sensor 170 is integrated into the heating apparatus. The temperature sensor 170 measures the temperature [symbol] ᵢₙ of the air flowing into the electric additional heater. The air flowing into the additional heater has the temperature [symbol] ᵢₙ of the air exiting from the water type heat exchanger.

The only signal that is supplied to the electric additional heater from the onboard electrical system of the automotive vehicle is the DF signal. The DF signal is a measure of the degree of utilization of the vehicle generator, the degree of utilization being indicated through the duty factor of the DF signal. For illustrating the electrical excitation of the generator rotor the DF signal is frequently indicated within a value range of 0% to 100%. The value 0% means almost no excitation and thus no power output to the onboard electrical system. By contrast, 100% means maximum excitation and thus maximum power output to the onboard electrical system with an unchanged onboard electrical system voltage (e.g. 14.5 V). When the power taken from the onboard electrical system is increased further at a 100% excitation, the onboard electrical system voltage starts to drop. Preferably, the power taken from the onboard electrical system is set such that an excitation, i.e. generator utilization, of 95% is achieved.

With the help of the DF signal, it is possible to adapt the power consumption of the electric additional heater to the degree of utilization of the vehicle generator. The DF signal is present in any automotive vehicle and can directly be tapped at the vehicle generator.

An alternative procedure for the adjustment of the power maximally taken from the onboard electrical system is based on the detection and evaluation of the onboard electrical system voltage. It can also be made out through the onboard electrical system voltage whether the generator is able to supply additional power to the onboard electrical system. It is the special advantage of this variant that no external signal has to be supplied to the electric additional heater in the automotive vehicle for this purpose, so that the additional heater is entirely independent of external signals. As a result, the installation of such an additional heater in an automotive vehicle is particularly simple and inexpensive.

For determining generator utilization, the onboard electrical system voltage is continuously monitored by the additional heater according to this alternative. The power consumption by the additional heater is always set such that the onboard electrical system voltage does not fall below a predetermined minimum value, for instance a value in the order of 14 V.

The generator controller, i.e. the controller of the electric generator of the automotive vehicle, permanently keeps the onboard electrical system voltage at a constant value by changing generator excitation. As soon as the maximum excitation has been reached, the onboard electric system voltage, however, starts to drop because it can no longer be compensated by increasing excitation. The onboard electrical system voltage drops to a value of about 12 V to 12.5 V when power is further taken up. At this voltage, additional electric power is taken from the battery of the automotive vehicle.

Since it has been found that in fact already at a degree of utilization of the generator in the range of about 85% the onboard electrical system voltage starts to drop slightly, the taking up of power of the additional heater can be set in a reliable manner to a predetermined degree of utilization of the generator; preferably, the degree of utilization is within a range of 90% to 100%, particularly preferably in the order of 95%.

Depending on the manufacturer and type of vehicle, the generator voltage can be varied on the basis of the outside temperature. The vehicle voltage is particularly raised at low temperatures. Accordingly, the voltage value of the onboard electrical system, which corresponds to a specific degree of utilization and must not be fallen below, is raised in the electric additional heater. Generally, the voltage is here varied within a range between 14.0 V and 14.5 V. With new batteries and types of vehicles, the charge voltage can be set in response to the temperature between about 14.0 V and 15.5 V. This is made possible by a changed chemical system of the battery.

While the onboard electrical system of an automotive vehicle is nowadays operated at a voltage of 12 V, future onboard electrical system will have a voltage of 42 V and provide much higher powers. As a result, the electrical power taken from the onboard electrical system for heating purposes can also be raised considerably. The above-indicated voltage values are set accordingly upon an increase in the onboard electrical system voltage.

The electric additional heater is only switched on when the engine is running, i.e. when electrical power is generated by the generator. This avoids a situation where electrical power is taken from the battery for heating purposes. To this end the control circuit of the heating apparatus monitors the onboard electrical system voltage of the automotive vehicle.

A start operation can be recognized with the help of the onboard electrical system voltage, inter alia, due to the fact that the onboard electrical system voltage drops suddenly and then rises again gradually to the initial value and higher.

At a battery voltage that is e.g. between 12.0 and 12.5 V, the onboard electrical system voltage drops suddenly to a value in the order of 6.0 V upon start of the engine. Subsequently, the onboard network voltage rises again gradually.

Another possibility of recognizing the start operation via the onboard electrical system voltage consists in directly weighting the voltage level. When the engine is switched off, the generator does not output any power and the onboard electrical system voltage corresponds to the battery (discharge) voltage. This voltage is typically within a range of 12.0 and 12.5 V. When the engine is running, the onboard electrical system voltage rises to the battery charge voltage. This voltage is typically within a range between 14.0 and 14.5 V.

The electric additional heater is activated when upon switching on of the ignition, i.e. upon start of the engine, the measured temperature [symbol] ᵢₙ is below a predetermined value [symbol] _{V}. Such a predetermined value [symbol] _{V} is e.g. in the order of 10° C. Upon start of the engine the measured temperature [symbol] _{In} corresponds to the actual outside temperature [symbol] _{A}.

The measured temperature [symbol] _{In}, however, differs from the outside temperature [symbol] _{A} when the engine still shows some residual heat, for instance because it was switched off before for a short period only. In such a case the temperature sensor 170 does not sense the outside temperature, but the ambient air heated via the residual heat of the heat exchanger.

To avoid an unnecessary switching on of the electric additional heater, the time is sensed that has passed since the last switching off of the engine. When the detected time Tₐᵤₛ does not exceed a predetermined minimum value T_{Min}, the additional heater will not be switched on.

It is only when the predetermined minimum value T_{Min} is exceeded that the additional heater will be switched on with the next engine start, on condition that the temperature switch-on criterion required for this is fulfilled. Typical numerical values for the minimum time value Tₘᵢₙ are within the range of several hours.

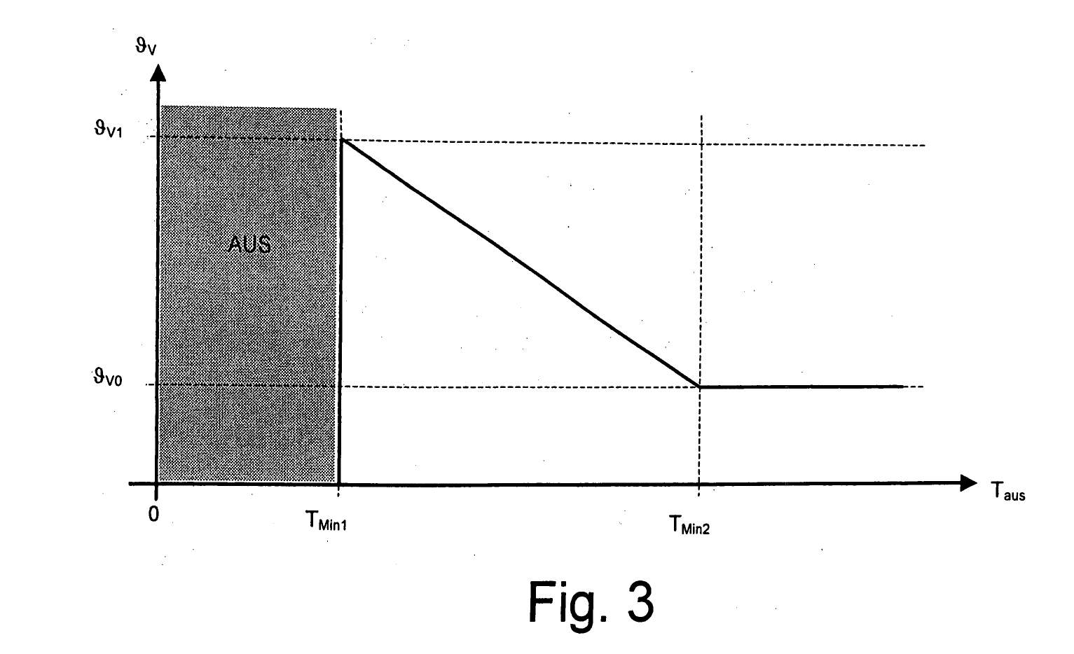

Instead of disabling the power supply to the PTC heating elements in response to time Tₐᵤₛ that has passed since the last switching off of the engine, the sensed time value Tₐᵤₛ can also be used for modifying the temperature threshold value [symbol] _{V}. As shown in FIG. 3, the temperature threshold value [symbol] _{V} supplied to the comparison means changes in response to the time Tₐᵤₛ that has passed.

Within a first time interval up to the predetermined time T_{Min1}, the power supply to the PTC heating elements remains disabled. Also independently of the temperature switch-on criterion the electric additional heater is not activated.

Within the time interval T_{Min1} to T_{Min2}, the temperature threshold value [symbol] _{V} is lowered from a value [symbol] _{V1} gradually to the stored lower temperature threshold value [symbol] _{V0}. The shorter the time that has passed since the last switching off of the engine, the higher is the temperature threshold value [symbol] _{V} and the more will the stored lower threshold value [symbol] _{V0} be raised. With an increase in the lapsed time Tₐᵤₛ, the temperature threshold value [symbol] _{V} passes into value [symbol] _{V0}. As soon as the time that has passed since the last switching off of the engine exceeds the value T_{Min2}, the minimum temperature threshold value [symbol] _{V0} will be used. The threshold value T_{Min2} is set such that the engine will completely cool from this time onwards.

As soon as the control circuit supplies power to the PTC heating elements, the air supplied to the passenger compartment will be heated accordingly. Preferably, the additional heater operates at the maximum heating power that is possible in dependence upon the onboard electrical system. The individual room temperature regulation is carried out via an air valve control for mixing hot and cold air.

As soon as the water type heat exchanger outputs enough heating heat, the additional heater will be switched off, namely in dependence upon the measured temperature of the air flowing into the additional heater. However, with the switching off operation, a considerable amount of heating energy is taken from the air flowing into the passenger compartment. This sudden change in temperature can also be noticed in the passenger compartment through the sudden change in temperature of the air flowing into the vehicle interior.

To permit a gradual switching off of the temperature, the heating power of the electric additional heater is switched off in dependence upon the cooling water temperature, for example. With a rising cooling water temperature, the heating power of the additional heater is gradually reduced to zero.

However, to avoid the supply of such an external temperature signal, the heating power of the electric additional heater is also reduced in dependence upon the measured temperature [symbol] _{In}. From the time when a certain temperature [symbol] _{In1} has been reached, the heating power is reduced from the maximally possible heating power P_{Max} with an increasing temperature of the inflowing air to the value P=0 when temperature [symbol] _{In2} is reached.

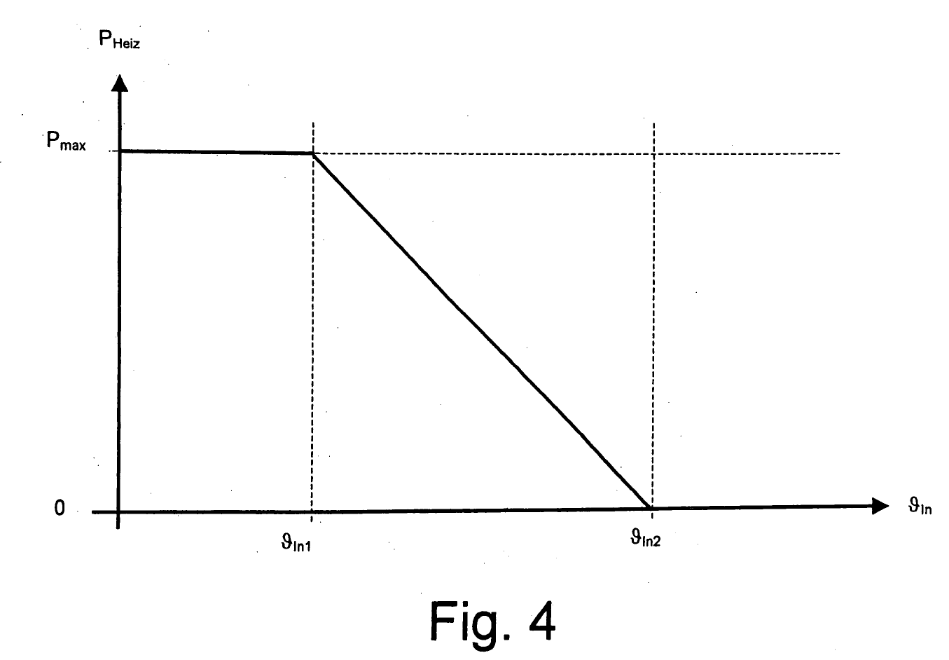

This relationship is diagrammatically shown in FIG. 4. After the additional heater has been switched on, the heating power P_{Heiz} is continuously reduced from the value Pₘₐₓ from the time when temperature [symbol] _{In} of the inflowing air has been reached, to the value zero. Starting from the value [symbol] _{In2}, heating power is no longer output by the additional heater. Typical values of the temperature limits [symbol] _{In1} and [symbol] _{In2} are 20° C. and 80° C. A transition, which is not felt by the passenger in the compartment of the automotive vehicle, can thus be achieved easily, i.e. without any external control signals.

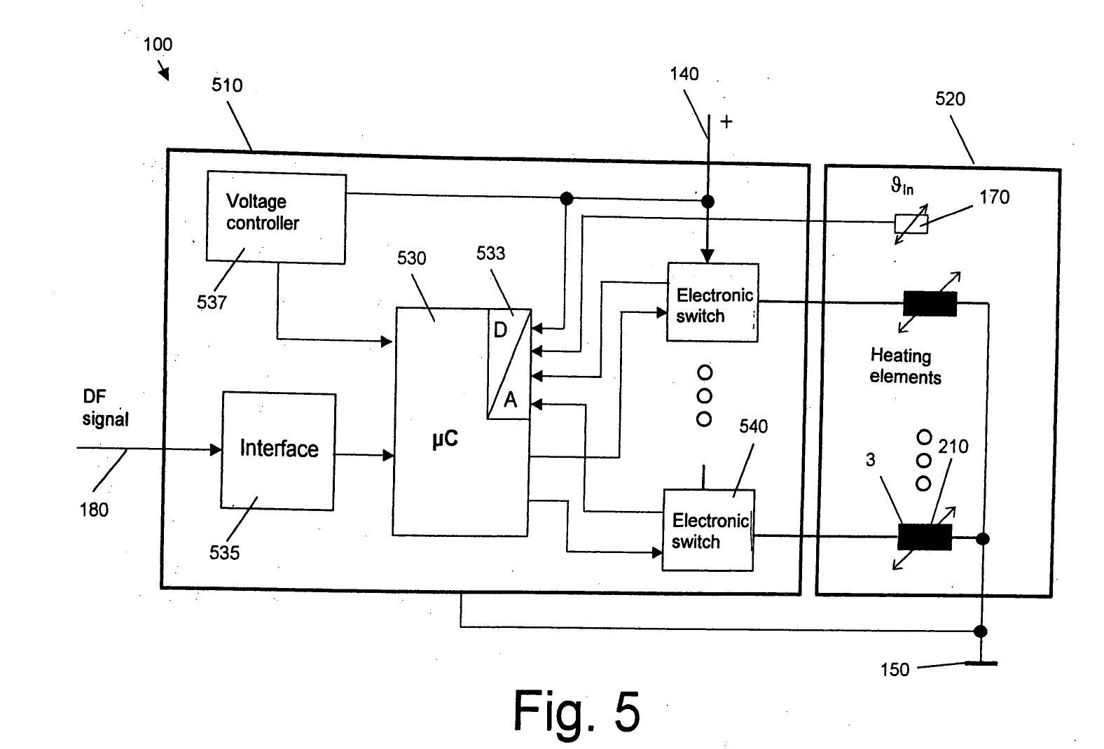

A detailed realization of an electric additional heater 100 is shown in FIG. 5 in the manner of a block diagram.

The electric additional heater comprises a control circuit 510 and a heating register 520. In the circuit design of FIG. 5, the housing of the heating register 520 has also assigned thereto the temperature sensor 170 which is arranged at the side where air flows onto the heating register. The value sensed by the temperature sensor 170 is is passed to the control circuit 510 and supplied via an analog/digital converter 533 to a computing unit 530. In dependence upon the temperature value [symbol] _{In} supplied, the control unit 530 controls the electronic switch 540. The electronic switches 540, which are preferably designed as power semiconductors, supply power from the terminal 140 to the heating elements 210.

For a maximum limitation of the power taken from the onboard electrical system of the vehicle via terminal 140, the control circuit senses, via the DF signal 180, the electrical power resources that are available in the automotive vehicle. The DF signal is supplied to the computing unit 530 via an interface means 535.

Moreover, the control circuit 510 includes a voltage controller 537 which provides the operational voltage for the computing unit 530, normally at the amount of 5 V.

For sensing the voltage of the onboard electrical system, said voltage is directly supplied from the terminal 140 via the analog/digital converter to the computing unit 530. With the help of the measured voltage of the onboard electrical system network, it is e.g. possible to reliably sense a start operation of the engine.

The temperature sensor 170 is preferably mounted on the electric additional heater such that it is not influenced by the heating up of the heating elements of the additional heater. Apart from the position shown in FIG. 1 for the temperature sensor 170, many other positions are possible.

The control circuit 510 is preferably integrated with the heating register 520 within housing. To this end the control circuit may be secured to one of the front sides of the heating register. However, an attachable or a separate, but neighboring, arrangement of the heating register 520 and the control circuit 510 is also possible.

To sum up, the present invention relates to an electric heating apparatus, particularly as an additional heater for an automotive vehicle, and to a control circuit for an electric heating apparatus that permits a substantially independent operation of the additional heater. The heating power control takes place via a temperature sensor integrated into the additional heater and limit values stored in the control circuit before.

1. A control circuit for operating an electric heating apparatus, particularly as an additional heater for an automotive vehicle, the heating apparatus comprising PTC heating elements and a temperature sensor which senses the temperature ( [symbol] _{In}) Of the air flowing into the heating apparatus, comprising:
storage means for storing a predetermined temperature threshold value ( [symbol] _{V}),
a comparator for comparing the temperature ( [symbol] _{In}) sensed by the temperature sensor with the stored temperature threshold value ( [symbol] _{V0}), and
activation means for enabling or interrupting power supply to the PTC heating elements depending on the comparison result of the comparator.

2. The control circuit according to claim 1, wherein the activation means enables power supply when the sensed temperature ( [symbol] _{In}) is below the temperature threshold value ( [symbol] _{V}).

3. The control circuit according to claim 1, wherein the temperature threshold value ( [symbol] _{V}) is within a range between 5° C. and 15° C., preferably between 8° C. and 10° C.

4. The control circuit according to claim 1, comprising detection means for detecting a start and/or switching off of the engine of the automotive vehicle.

5. The control circuit according to claim 4, comprising a time sensing means for sensing the period of time (Tₐᵤₛ) that has passed since the switching off of the engine.

6. The control circuit according to claim 5, wherein
the storage means stores a predetermined period of time (T_{Min}),
the control circuit comprises a comparator for comparing a period of time (Tₐᵤₛ) that has passed since the switching off of the engine, with the predetermined period of time (T_{Min}), and
the activation means disables the supply of power to the PTC heating elements when the sensed period of time (Tₐᵤₛ) falls below the predetermined period of time (Tₘᵢₙ).

7. The control circuit according to claim 6, wherein the stored period of time (T_{Min}) is within the range of 1 to 5 hours, preferably between 2 and 3 hours.

8. The control circuit according to claim 1, comprising a modification means for weighting the stored temperature threshold value ( [symbol] _{V0}) before comparison with the sensed temperature ( [symbol] _{In}).

9. The control circuit according to claim 8, wherein the modification means raises the stored temperature threshold value ( [symbol] _{V0}) in dependence upon the period of time (Tₐᵤₛ) that has passed since the switching off of the engine, namely such that the raised temperature threshold value ( [symbol] _{V}) approaches the stored temperature threshold value ( [symbol] _{V0}) with an increasing period of time (Tₐᵤₛ).

10. The control circuit according to claim 8, wherein the modification means changes the stored temperature threshold value ( [symbol] _{V0}) such that the stored temperature threshold value ( [symbol] _{V0}) is first raised to an increased temperature threshold value ( [symbol] _{V1}) and is lowered with an increasing period of time (Tₐᵤₛ) to the stored temperature threshold value ( [symbol] _{V0}).

11. The control circuit according to claim 10, wherein the modification means lowers the stored temperature threshold value ( [symbol] _{V0}) within a time interval between a first predetermined time (T_{Min1}) after the switching off of the engine and a second predetermined time (T_{Min2}) after the switching off of the engine from a predetermined increased temperature threshold value ( [symbol] _{V1}) to the stored temperature threshold value ( [symbol] _{V0}).

12. The control circuit according to claim 6, wherein the activation means interrupts the power supply to the PTC heating elements between the switching off of the engine and a first predetermined time (T_{Min1}) after the switching off of the engine.

13. The control circuit according to claim 1, comprising a power control means for adjusting the amount of power supplied to the PTC heating elements.

14. The control circuit according to claim 13, wherein the power control means adjusts the amount of power in dependence upon the amount of power available in the onboard electrical system of the automotive vehicle.

15. The control circuit according to claim 14, wherein the power control means adjusts the amount of power taken from the onboard electrical system in dependence upon the sensed level of the onboard electrical system voltage.

16. The control circuit according to claim 15, wherein the power control means adjusts the amount of power taken from the onboard electrical system such that a predetermined value of the onboard electrical system voltage is not fallen below.

17. The control circuit according to claim 16, wherein the predetermined value of the onboard electrical system voltage is varied in dependence upon the sensed temperature ( [symbol] _{In}) of the supply air, particularly at low temperatures.

18. The control circuit according to claim 14, wherein the power control means is connectable to an external signal line which is indicative of the amount of power available in the onboard electrical system.

19. The control circuit according to claim 18, wherein the external signal line is the DF signal of a generator of the automotive vehicle.

20. The control circuit according to claim 13, wherein the power control means adjusts the amount of power supplied to the PTC heating elements in dependence upon the sensed temperature ( [symbol] _{In}).

21. The control circuit according to claim 20, wherein while the power supply to the PTC heating elements is enabled at a sensed temperature ( [symbol] _{In}) lower than a first predetermined temperature ( [symbol] _{In1}) the power control means supplies a maximally available amount of power to the PTC heating elements.

22. The control circuit according to claim 21, wherein the power control means interrupts the power supply to the PTC heating elements as soon as the sensed temperature ( [symbol] _{In}) has reached a second predetermined temperature ( [symbol] _{In2}).

23. The control circuit according to claim 22, wherein the power control means reduces the amount of power supplied to the PTC heating elements in the temperature interval between the first predetermined temperature ( [symbol] _{In1}) and the second predetermined temperature ( [symbol] _{In2}) from a maximally possible heating power (Pₘₐₓ) to zero.

24. The control circuit according to claim 23, wherein the first predetermined temperature ( [symbol] _{In1}) is within a range of 10° C. to 25° C., preferably between 18° C. and 22° C.

25. The control circuit according to claim 23, wherein the second predetermined temperature ( [symbol] _{In2}) is within a range of 50° C. to 90° C., preferably between 75° C. and 85° C.

26. An additional heater for an automotive vehicle, comprising PTC heating elements and a temperature sensor which senses the temperature ( [symbol] _{In}) of the air flowing into the heater, and a control circuit for enabling or disabling the power supply to the PTC heating elements, wherein the control circuit is designed according to claims 1.

27. A method of operating an electric heating apparatus, particularly as an additional heater for an automotive vehicle, wherein the heating apparatus comprises PTC heating elements and a temperature sensor which senses the temperature ( [symbol] _{In}) of the air flowing into the heating apparatus, comprising the steps of:
sensing the temperature of the air flowing into the heating apparatus by means of the temperature sensor,
comparing the temperature ( [symbol] _{In}) sensed by the temperature sensor with the stored temperature threshold value ( [symbol] _{V}), and
enabling or disabling the power supply to the PTC heating elements depending on the comparison result.

28. The method according to claim 27, wherein the power supply is enabled when the sensed temperature ( [symbol] _{In}) is below the temperature threshold value ( [symbol] _{V}).

29. The method according to claim 27, wherein the temperature threshold value ( [symbol] _{V}) is within a range between 5° C. and 15° C., preferably between 8° C. and 10° C.

30. The method according to claim 28, comprising the additional steps of:
sensing a period of time (Tₐᵤₛ) which has passed since the switching off of the engine,
comparing the period of time (Tₐᵤₛ) which has passed since the switching off of the engine, with a predetermined period of time (T_{Min}), and
disabling the supply of power to the PTC heating elements when the sensed period of time (Tₐᵤₛ) falls below the predetermined period of time (T_{Min}).

31. The method according to claim 30, wherein the stored period of time (T_{Min}) is within the range of 1 to 5 hours, preferably between 2 and 3 hours.

32. The method according to claim 27, comprising the further step of weighting the stored temperature threshold value ( [symbol] _{V0}) before comparison with the sensed temperature ( [symbol] _{In}).

33. The method according to claim 32, wherein the stored temperature threshold value ( [symbol] _{V0}) is raised in dependence upon the period of time (Tₐᵤₛ) that has passed since the switching off of the engine, namely such that the raised temperature threshold value ( [symbol] _{V}) approaches the stored temperature threshold value ( [symbol] _{V)}) with an increasing period of time (Tₐᵤₛ).

34. The method according to claim 32, wherein the stored temperature threshold value ( [symbol] _{V0}) is changed such that the stored temperature threshold value ( [symbol] _{V0}) is first raised to an increased temperature threshold value ( [symbol] _{V1}) and is lowered with an increasing period of time (Tₐᵤₛ) to the stored temperature threshold value ( [symbol] _{V0}).

35. The method according to claim 32, wherein the stored temperature threshold value ( [symbol] _{V0}) is lowered within a time interval between a first predetermined time (T_{Min1}) after the switching off of the engine and a second predetermined time (T_{Min2}) after the switching off of the engine from a predetermined raised temperature threshold value ( [symbol] _{V1}) to the stored temperature threshold value ( [symbol] _{V0}).

36. The method according to claim 27, wherein the power supply to the PTC heating elements is interrupted between the switching off of the engine and a first predetermined time (T_{Min1}) after the switching off of the engine.

37. The method according to claim 27, wherein the heating power is adjusted in dependence upon the power available in the onboard electrical system of the automotive vehicle.

38. The method according to claim 37, wherein the heating power is adjusted in dependence upon the sensed level of the onboard electrical system voltage.

39. The method according to claim 38, wherein the amount of power taken from the onboard electrical system is adjusted such that a predetermined value of the onboard electrical system voltage is not fallen below.

40. The method according to claim 39, wherein the predetermined value of the onboard electrical system voltage is varied in dependence upon the sensed temperature ( [symbol] _{In}) of the supply air, particularly at low temperatures.

41. The method according to claim 37, wherein the heating power is adjusted in dependence upon the DF signal of the generator of the automotive vehicle.

42. The method according to claim 27, wherein the heating power of the PTC heating elements is adjusted in dependence upon the sensed temperature ( [symbol] _{In}).

43. The method according to claim 42, wherein the heating power of the PTC heating elements is adjusted to a maximum heating power when the power supply to the PTC heating elements is enabled at a sensed temperature ( [symbol] _{In}) that is lower than a first predetermined temperature ( [symbol] _{In1}).

44. The method according to claim 43, wherein the heating power of the PTC heating elements is set to zero as soon as the sensed temperature ( [symbol] _{In}) has reached a second predetermined temperature ( [symbol] _{In2}).

45. The method according to claim 44, wherein the heating power of the PTC heating elements within the temperature interval between the first predetermined temperature ( [symbol] _{In1}) and the second predetermined temperature ( [symbol] _{In2}) is reduced from a maximally possible heating power (Pₘₐₓ) to zero.

46. The method according to claim 45, wherein the first predetermined temperature ( [symbol] _{In1}) is within a range of 10° C. to 25° C., preferably between 18° C. and 22° C.

47. A control circuit for operating an additional heater for an automotive vehicle, the additional heater including PTC heating elements and a temperature sensor which senses the temperature ( [symbol] _{In}) of the air flowing into the heating apparatus, the control circuit comprising:
a storage device that stores a predetermined temperature threshold value ( [symbol] _{V}),
a comparator that compares the temperature ( [symbol] _{In}) sensed by the temperature sensor with the stored temperature threshold value ( [symbol] _{V0}), and
an activator that enables or interrupts a power supply to the PTC heating elements depending on the comparison result of the comparator.

48. The control circuit according to claim 47, wherein the activator enables the power supply to the PTC heating elements when the sensed temperature ( [symbol] _{In}) is below the temperature threshold value ( [symbol] _{V}).

49. The control circuit according to claim 47, further comprising a detector that detects a start and/or switching off of an engine of an automotive vehicle in whch the storage device is installed.

50. The control circuit according to claim 49, further comprising a timer that senses the period of time (Tₐᵤₛ) that has passed since the switching off of the engine.

51. The control circuit according to claim 47, further comprising a modification device that weights the stored temperature threshold value ( [symbol] _{V0}) before comparison with the sensed temperature ( [symbol] _{In}).

52. The control circuit according to claim 47, further comprising a power controller that adjusts the amount of power supplied to the PTC heating elements.

53. An additional heater for an automotive vehicle, comprising:
PTC heating elements;
a temperature sensor which senses the temperature ( [symbol] _{In}) of the air flowing into the heater; and
a control circuit that enables or disables the power supply to the PTC heating elements, wherein the control circuit includes
a storage device that stores a predetermined temperature threshold value ( [symbol] _{V}),
a comparator that compares the temperature ( [symbol] _{In}) sensed by the temperature sensor with the stored temperature threshold value ( [symbol] _{V0}), and
an activator that enables or interrupts a power supply to the PTC heating elements depending on the comparison result of the comparator.

54. A method of operating an additional heater for an automotive vehicle, wherein the heating apparatus comprises PTC heating elements and a temperature sensor which senses the temperature ( [symbol] _{In}) of the air flowing into the heating apparatus, the method comprising:
sensing the temperature of the air flowing into the heating apparatus by operation of the temperature sensor,
comparing the temperature ( [symbol] _{In}) sensed by the temperature sensor with the stored temperature threshold value ( [symbol] _{V}), and
enabling or disabling the power supply to the PTC heating elements depending on the comparison result.

55. The method according to claim 54, wherein the power supply is enabled when the sensed temperature ( [symbol] _{In}) is below the temperature threshold value ( [symbol] _{V}).

56. The method according to claim 54, further comprising
sensing a period of time (Tₐᵤₛ) which has passed since the switching off of the engine,
comparing the period of time (Tₐᵤₛ) which has passed since the switching off of the engine, with a predetermined period of time (T_{Min}), and
disabling the supply of power to the PTC heating elements when the sensed period of time (Tₐᵤₛ) falls below the predetermined period of time (T_{Min}).

57. The method according to claim 54, further comprising
weighting the stored temperature threshold value ( [symbol] _{V0}) before comparison with the sensed temperature ( [symbol] _{In}).

58. The method according to claim 54, further comprising interrupting the power supply to the PTC heating elements between the switching off of the engine and a first predetermined time (T_{Min1}) after the switching off of the engine.

59. The method according to claim 54, further comprising adjusting the heating power of the PTC heating elements in dependence upon the power available in the onboard electrical system of the automotive vehicle.

60. The method according to claim 54, further comprising adjusting the heating power of the PTC heating elements in dependence upon the sensed temperature ( [symbol] _{In}).
